(19) United States
(12) Patent Application Publication
(10) Pub. No.: US 2024/0065511 A1
(43) Pub. Date: Feb. 29, 2024

(54) Cleaning Device and Steam Control

(71) Applicant: Anker Innovations Technology Co., Ltd., Changsha (CN)

(72) Inventors: Qinghe Fan, Shenzhen (CN); Guisheng Nong, Shenzhen (CN)

(21) Appl. No.: 18/237,105

(22) Filed: Aug. 23, 2023

(30) Foreign Application Priority Data
Aug. 25, 2022 (CN) 202211030856.4

(51) Int. Cl. A47L 11/40

(52) U.S. Cl. CPC A47L 11/4086; A47L 11/4011

(57) ABSTRACT

This application describes a cleaning device and a steam control method. The cleaning device may comprise a power source, a steam generating device, and a controller. The steam generating device may comprise a steam boiler and a temperature sensor. The steam boiler may be electrically connected to the power source, and the temperature sensor can be used to measure the temperature of the steam boiler or internal liquid. The controller may be configured to control the output voltage of the power source to generate steam by heating the steam boiler.

### CROSS-REFERENCE TO RELATED APPLICATION

The present application claims priority to CN Application No. 202211030856.4, filed on Aug. 25, 2022. The above application is incorporated by reference in its entirety.

### FIELD

The present application relates to the field of cleaning technology, particularly to cleaning equipment and steam control methods.

### BACKGROUND

Currently, in cleaning equipment with steam functions (e.g., steam vacuum cleaner), steam control methods often connect temperature fuses and temperature switches between alternating current (AC) and boilers. The disadvantage of using temperature switches to achieve over-temperature protection and energy control by over-temperature circuit breaking is that if the boiler has triggered over-temperature protection, the time it takes for the temperature switch to recover is prolonged, which can cause interruptions in steam and affect the user's experience.

### SUMMARY

The present application describes a cleaning device and steam control methods that can effectively control the stable production of steam in a steam boiler of the cleaning device and avoid the consequences of over-temperature.

The present application describes a cleaning device. The cleaning device may comprise a power supply, a steam generation component (e.g., device), and a controller. The power supply may be configured for power supply. The steam generation component may comprise a steam boiler for heating the internal liquid to produce steam and a temperature sensor set on the steam boiler. The steam boiler may be electrically connected to the power supply, and the temperature sensor may be used to measure the temperature of the steam boiler or the internal liquid. The controller may be electrically connected to the power supply and the temperature sensor, and may be configured to control the output voltage of the power supply so that the steam boiler is heated to produce steam under the output voltage. The controller may be configured to obtain the temperature measured by the temperature sensor during the heating process of the steam boiler, compare the temperature with the preset working temperature of the steam boiler, obtain the comparison result, and adjust the output voltage of the power supply according to the comparison result.

Additionally, the present application describes one or more steam control methods. The steam control methods may be applied to the above-mentioned cleaning device. The steam control methods may comprise: controlling an output voltage of a power supply to a steam boiler so that the steam boiler is heated to produce steam under the output voltage; obtaining a temperature measured by a temperature sensor during the heating process of the steam boiler; comparing the temperature with a preset working temperature of the steam boiler to obtain the comparison result; and adjusting the output voltage of the power supply according to the comparison result.

Beneficial effects of the present application include: different from the existing technology, the method of controlling the output voltage of the power supply can be used to produce stable steam in the steam boiler, and the over-temperature protection strategy can be realized by obtaining the temperature of the steam boiler through the temperature sensor to prevent the high-temperature steam generated by the steam boiler from causing unnecessary burns or other dangers to the user.

### BRIEF DESCRIPTION OF THE DRAWINGS

FIG. 1 shows a schematic diagram of a circuit structure of a cleaning device;

FIG. 2 shows a schematic diagram of a circuit structure of the cleaning device;

FIG. 3 shows a schematic diagram of a circuit structure of the cleaning device;

FIG. 4 shows a flowchart of a steam control method of the cleaning device;

FIG. 5 shows a flowchart of a steam control method of the cleaning device.

### DETAILED DESCRIPTION

The following will describe technical solutions of the present application in a clear and complete manner, with reference to the accompanying drawings. It is apparent that the described examples are only a part of the present application, not all of them. Based on the examples of the present application, all other examples obtained by those skilled in the art without creative labor are within the scope of protection of the present application.

The following description of a cleaning device 10 illustrates an example of the structural of the cleaning device 10.

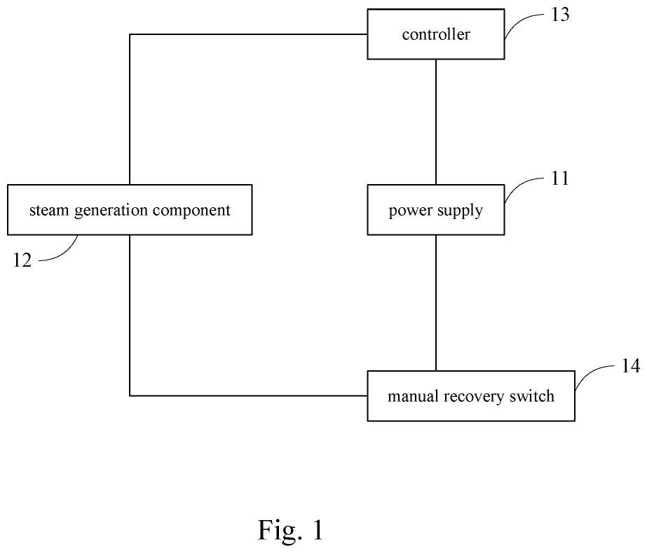

FIG. 1 is a schematic diagram of the circuit structure of the cleaning device 10. The cleaning device 10 can be a steam cleaning machine (e.g., steam vacuum cleaner, steam cleaner). The steam cleaning machine may be a cleaning device that uses the high temperature and high pressure of saturated steam to clean the oil stains and dirt (and other dust) on the surface of objects (e.g., floor), and to vaporize and evaporate the oil stains and dirt. The steam cleaning machine can clean any small gaps and holes, peel off and remove oil stains and residues, and achieve the requirements of high efficiency, water saving, cleanliness, dryness, and low cost. The cleaning device 10 can also be other cleaning devices that use saturated steam for cleaning, such as household floor scrubbers. In addition to household use, the cleaning device 10 can also be applied in other fields, such as cleaning milling machines, computer numerical control (CNC) machine tools and foundry equipment, and cleaning injection molding machine tools.

The cleaning device 10 may include a power supply 11, a steam generating component 12 (e.g., a steam generating device), and a controller 13. The power supply 11 may be configured to provide power supply. For example, the power supply 11 may be configured to provide power to the steam generating component 12 and/or the controller 13. The steam generating component 12 may be configured to heat the internal liquid and generating steam. The controller 13 may be configured to control the output voltage of the power supply 11 to the steam generating component 12, so that the steam generating component 12 can heat the internal liquid and produce steam. In an example, the cleaning device may also include a manual temperature recovery switch 14. The manual temperature recovery switch 14 may be configured to shut down the cleaning device 10 in case of emergencies, such as when the steam generating component 12 is working abnormally, the cleaning device 10 can be directly shut down through the manual temperature recovery switch 14 (e.g., by a user of the cleaning device 10).

The power supply 11 may be connected in series with the steam generating component 12, the controller 13, and the manual temperature recovery switch 14. If the manual temperature recovery switch 14 is closed, the power supply 11 may supply power to the steam generating component 12, and heat the liquid inside the steam generating component 12 to produce steam. The power supply 11 may continuously heat the steam generating component 12, and the generated steam may continuously take away heat, thereby achieving dynamic balance. The generated steam can be used for cleaning in different application scenarios. For example, the liquid heated by the steam generating component 12 can be water, ethanol, 75% ethanol, or other cleaning agents, disinfectants, etc. The rated power required to heat different types of liquids of different volumes to the boiling point may be different, and different liquids can be heated by controlling the output voltage of the power supply 11. For example, when heating water, the temperature needs to be heated to at least 100 degrees Celsius to produce steam.

The power supply 11 can be AC power or any rechargeable battery. In an example, the power supply is a rechargeable battery. A storage battery may be a device that directly converts chemical energy into electrical energy. It is designed for rechargeability and is usually referred to as a lead-acid battery, which is a type of battery: a secondary battery. The working principle of a storage battery may comprise: during charging, the internal active material may be regenerated by external electrical energy, and the electrical energy may be stored as chemical energy. When it needs to be discharged, the chemical energy may be converted into electrical energy and output.

The storage battery is one of the most widely used batteries. The advantage of the storage battery is that it can be used repeatedly through charging. In addition, because of its extremely low internal resistance, it can provide a large current. Setting the power supply as a rechargeable battery avoids the disadvantages of AC power lines being difficult to move, easy to touch, trip over, and entangle obstacles. For example, the power supply 11 can be a lead-acid battery, an uninterruptible power supply (UPS) battery, a lithium iron phosphate battery, or other types of batteries. The power supply 11 can also be batteries of different sizes or combinations thereof, and different types of power supplies 11 can be set according to the application scenarios of the cleaning device 10. In another example, users who need to use the cleaning device for a long time in certain fixed places can also directly connect the cleaning device to AC power through an AC power cord (not shown), which can avoid the need to constantly charge the battery.

The controller 13 can be one or more processors or one or more microprocessors. A microprocessor may be a central processor composed of one or a few large-scale integrated circuits (chips), and these central processors can perform the functions of control components and arithmetic logic components, such as completing instruction fetching, instruction execution, and exchanging information with external memory and logic components.

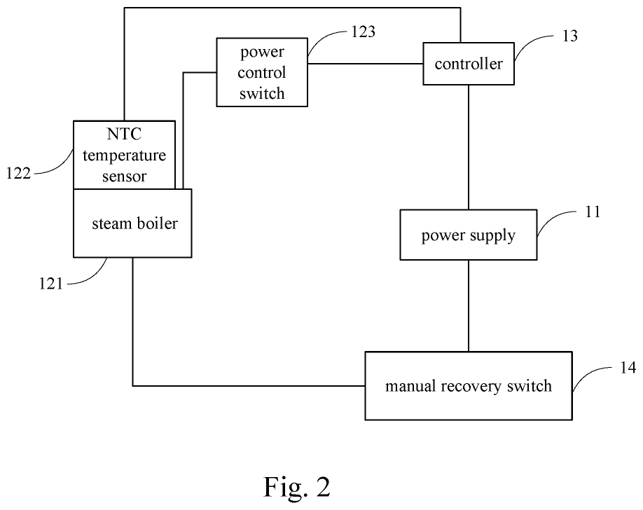

FIG. 2 shows a circuit structure diagram of the cleaning device 10. The steam generating component 12 can include a steam boiler 121 for heating the liquid to generate steam and a temperature sensor 122 set on the steam boiler. The steam generating component 12 may also include a power control switch 123. The steam boiler 121 may be electrically connected to the power supply 11. The power control switch 123 may be connected in series between the power supply 11 and the steam boiler 121. The power control switch 123 may be electrically connected to the controller 13. The temperature sensor 122 may be electrically connected to the controller 13.

The steam boiler 121 can be a small electric steam boiler, and its structure can be a vertical or horizontal structure. The vertical structure can be a single or double return vertical structure. In an example, when the cleaning device 10 is used in large factories, shopping malls, hospitals, companies and other application scenarios, the steam boiler 121 can also be a medium-sized electric steam boiler or a large electric steam boiler, and can be a three-return horizontal structure. The volume and structure of the steam boiler 121 can be specifically set according to the equipment or place to be cleaned to meet the needs of different users. For example, in a household floor sweeper, the steam boiler 121 can be a small electric steam boiler, and its volume can be set to 1 L, 2 L, 3 L, etc. The structure of the steam boiler 121 can be a horizontal structure.

The temperature sensor 122 may be configured to measure the temperature of the steam boiler 121 or the liquid inside the steam boiler 121. The temperature sensor 122 may comprise an NTC (Negative Temperature Coefficient) temperature sensor. The NTC temperature sensor may comprise an NTC thermistor, a probe, extension leads, and metal terminals or connectors. The NTC thermistor may be manufactured using ceramic technology and mainly comprise metal oxides such as manganese, cobalt, nickel, and copper. These metal oxide materials have semiconductor properties, which are similar to semiconductor materials such as germanium and silicon in terms of conduction mode. When the temperature is low, the number of carriers (electrons and holes) in these oxide materials is small, so their resistance is high. As the temperature increases, the number of carriers increases, so the resistance decreases. The variation range of the NTC thermistor at room temperature is 100-1000000 ohms, and the temperature coefficient is −2[%]˜−6.5[%]. Therefore, the resistance value of the NTC temperature sensor rapidly decreases as the temperature rises. Using this characteristic, the NTC temperature sensor may determine the corresponding temperature by measuring its resistance value, thereby achieving the purpose of detecting temperature.

The temperature sensor 122 can be set on the outside of the steam boiler 121, for example, by attaching the temperature sensor 122 to the outer wall of the steam boiler 121. Setting the temperature sensor 122 on the outside of the steam boiler 121 makes it more convenient to install and avoids contact with the liquid inside the steam boiler 121 to prevent corrosion. Alternatively, the temperature sensor 122 can also be set inside the steam boiler 121. Setting the temperature sensor 122 inside the steam boiler 121 may be more conducive to collecting the true temperature of the liquid inside the steam boiler 121. In FIG. 2, the temperature sensor 122 is attached to the outer wall of the steam boiler 121.

Furthermore, the temperature sensor 122 may be an unpackaged NTC temperature sensor. The probe of the NTC temperature sensor can be packaged in different forms. For example, it can be packaged in epoxy resin, aluminum shell, copper shell, stainless steel shell, plastic shell, fixed metal sheet, and other special forms. When the unpackaged NTC temperature sensor is in direct contact with the steam boiler 121, it can further improve the sensitivity of the NTC temperature sensor, thereby making the transmission of temperature information more accurate and more conducive to the controller 13 to adopt strategies to control the temperature.

The power control switch 123 can be used to open and close the series circuit that comprises the power supply 11, the steam generating component 12, the controller 13, and the manual reset switch 14. The power control switch 123 can be a field-effect transistor switch. The field-effect transistor (FET), also known as a unipolar transistor, is a voltage-controlled semiconductor device that has the advantages of high input resistance (107-1015Q), low noise, low power consumption, large dynamic range, easy integration, no secondary breakdown phenomenon, and a wide safe operating area. There are mainly two types of FETs: junction field-effect transistors (JFETs) and metal-oxide-semiconductor field-effect transistors (MOSFETs). JFET is a three-terminal active device with amplification function composed of a P-N junction gate (G), a source (S), and a drain (D). The working principle of JFET may be to control the output current by changing the conductivity of the channel with voltage. MOSFET can be divided into “N-type” and “P-type” according to the polarity of its “channel,” usually referred to as NMOSFET and PMOSFET, respectively. When MOSFET is used as a switch, the source and drain are different from other applications, and the signal can enter and exit from any end outside the MOSFET gate. For NMOS switches, the most negative end is the source, while for PMOS, the most positive end is the source. The signal that MOSFET switches can transmit is limited by the voltage between the gate-source, gate-drain, and drain-source. If the voltage exceeds the upper limit, the MOSFET may burn out. When NMOS is used as a switch, its base is grounded, and the gate is the endpoint of the switch. When the gate voltage minus the source voltage exceeds the critical voltage of conduction, the state of this switch is conductive. As the gate voltage continues to rise, the current that NMOS can pass becomes larger. When NMOS is used as a switch, it operates in the linear region because the voltage between the source and drain tends to be consistent when the switch is conductive. When PMOS is used as a switch, its base is connected to the highest potential in the circuit, usually the power supply. When the gate voltage is lower than the source voltage and exceeds its critical voltage, the PMOS switch will open. In addition to NMOS and PMOS, a CMOS (dual MOSFET) consisting of a PMOS plus an NMOS can also be used as a switch. The CMOS switch connects the source and drain of PMOS and NMOS together, and the connection method of the gate is the same as the traditional connection method of NMOS and PMOS. Optionally, the power control switch 123 can be a JFET switch or a MOSFET switch. Furthermore, the power control switch 123 can be a single MOSFET switch or a dual MOSFET switch. In some simpler application scenarios, the power control switch 123 can be a single MOSFET switch, while in some more complex application scenarios, the power control switch 123 can be a dual MOSFET switch.

The controller 13 may include a Pulse Width Modulation (PWM) controller. PWM is a method of digitally encoding analog signal levels. By using a high-resolution counter, the duty ratio of a square wave is modulated to encode the level of a specific analog signal. Duty ratio refers to the proportion of time that the power is on relative to the total time within a pulse cycle. The basic principle of PWM control is that narrow pulses with equal impulse but different shapes have the same effect when applied to an inertial element. The control principle of PWM may be as follows: the waveform is divided into, for example, 6 equal parts, which can be replaced by 6 square waves. There are various methods of classifying PWM modulation, such as unipolar and bipolar, synchronous and asynchronous, rectangular wave modulation and sine wave modulation. Unipolar PWM control refers to the carrier changing only in one direction during half a cycle, resulting in the PWM waveform changing only in one direction, while bipolar PWM control changes the carrier in two directions during half a cycle, resulting in the PWM waveform changing in two directions. For example, if the circuit of power supply 11 is turned on for half a working cycle, then its duty ratio is 50%. If the signal voltage of the power supply 11 is 5V, then the actual working voltage average or effective voltage is 2.5V. PWM signal may comprise digital information, and at any given time, the full-scale DC power supply is either fully on (ON) or fully off (OFF). The voltage or current source is added to the analog load in a repeated pulse sequence that is either on (ON) or off (OFF). When it is on, the DC power supply may be added to the load, and when it is off, the power supply may be disconnected.

The controller 13 can be configured to control the output voltage of the power supply 11 to the steam boiler 121 through the power control switch 123. Moreover, the controller 13 may be configured to control the opening and closing of the power control switch 123 to adjust the duty ratio of the output voltage of power supply 11, thereby controlling the output voltage of power supply 11. In an example, the cleaning device 10 may be a household sweeper, and the rated power of steam boiler 121 when filled with water is 200 W. The output voltage of power supply 11 is 20V. The controller 13 can control the power control switch 123 to remain in the open state, and the duty ratio of the output voltage of the power supply 11 is 100%, so when the circuit is fully connected, the heat generated by the steam boiler 121 may transfer to the water in the steam boiler 121 and raise its temperature to 100 degrees Celsius, producing steam. At this time, the cleaning device 10 can start working. After a period of time, when the water level in the steam boiler 121 is 50% of the full load, the power required by cleaning device 10 is 100 W. The controller 13 may be configured to control the power control switch 123 to be open for 50% of the time (e.g., the duty ratio is 50%), and the actual average working voltage or effective voltage is 9V. Similarly, after another period of time, when the water level in the steam boiler 121 is 20% of the full load, the power required by the cleaning device 10 is 40 W. The controller 13 may be configured to control the power control switch 123 to be open for 20% of the time (e.g., the duty ratio is 20%), the actual average working voltage or effective voltage is 3.6V. Therefore, by controlling the power control switch 123 through the controller 13, the duty ratio can be adjusted within the range of 0% to 100%, to meet the heating needs of different types and volumes of liquids with different power requirements.

Furthermore, the controller 13 can also be configured to obtain the temperature measured by the temperature sensor 122 during the heating process of the steam boiler 121, compare the temperature with a preset working temperature of the steam boiler 121, obtain the comparison result, and adjust the output voltage of the power supply 11 according to the comparison result. For example, the controller 13 may be configured to collect the current maximum output voltage that the power supply 11 can provide, compare the current maximum output voltage with a preset working voltage corresponding to the preset working power of the steam boiler 121.

If the current maximum output voltage is greater than the preset working voltage, the controller 13 may be configured to control the output voltage of the power supply 11 to output at the preset working voltage. For example, if the preset working voltage corresponding to the preset working power of the steam boiler 121 is 20V, and the current maximum output voltage of the power supply 11 is 22V (e.g., when the power supply 11 is fully charged), the controller 13 can detect that the output voltage of the power supply 11 exceeds the preset working voltage based on the built-in program, and then control the opening and closing time of power control switch 123 to reduce the duty cycle of the voltage (e.g., the output voltage of power supply 11). In this case, the controller 13 may be configured to reduce the voltage duty cycle to avoid the steam boiler 121 from being continuously heated and producing too much steam.

If the current maximum output voltage is less than the preset working voltage, the controller 13 may be configured to control the output voltage of the power supply 11 to output at the maximum output voltage. For example, if the preset working voltage corresponding to the preset working power of the steam boiler 121 is 20V, and the current maximum output voltage of the power supply 11 is 18V (e.g., when the power supply 11 has been working for a period of time), the controller 13 may be configured to control the power supply 11 to output voltage at the maximum output voltage of 18V. In this case, controller 13 may be configured to control the power supply 11 to output voltage at the maximum output voltage to keep the steam boiler 121 in a continuous heating state and produce enough steam.

Furthermore, the controller 13 may be configured to compare the temperature measured by the temperature sensor 122 during the heating process of the steam boiler 121 with a preset working temperature of the steam boiler 121 to obtain the comparison result. If the difference between the temperature and the preset working temperature is greater than a preset threshold range, the controller 13 may be configured to control the power supply 11 to adjust the output voltage of the power supply 11 so that the difference between the temperature and the preset working temperature is within the preset threshold range. For example, the preset threshold range can be set, for example, to 5 degrees Celsius. When the difference between the temperature measured by the temperature sensor 122 and the preset working temperature is greater than 5 degrees Celsius, the controller 13 may be configured to control the power supply 11 to adjust the output voltage of the power supply 11 so that the difference between the temperature and the preset working temperature is within 5 degrees Celsius. The preset threshold range can also be set to other values, such as 2 degrees Celsius, 4 degrees Celsius, etc.

If the comparison result indicates that the temperature is higher than the preset working temperature and the difference is greater than the preset threshold range, then controller 13 may be configured to control the power supply 11 to reduce the output voltage of the power supply 11. The preset working temperature can be set according to the type of liquid loaded in the steam boiler 121. For example, when the liquid is water, it can be set to 100 degrees Celsius, and when the liquid is ethanol, it can be set to 78 degrees Celsius (e.g., the boiling point of ethanol). For example, if the preset threshold range is set to 5 degrees Celsius and the liquid loaded in the steam boiler 121 of the cleaning device 10 is water, when the temperature measured by the temperature sensor 122 is greater than the preset working temperature by more than or equal to 5 degrees Celsius (e.g., 105 degrees Celsius), the controller 13 may be configured to control the power supply 11 to reduce the output voltage of the power supply 11. The controller 13 may be configured to control the opening and closing time of the power control switch 123 to reduce the duty cycle of the voltage, thereby reducing the output voltage of the power supply 11. After a period of time (e.g., a preset time interval), the controller 13 may be configured to obtain the temperature measured by the temperature sensor 122 again. If the temperature is higher than the preset working temperature but the difference is less than the preset threshold range, for example, 102 degrees Celsius, then the power supply may be provided according to the current output voltage.

If the comparison result is that the temperature is lower than the preset working temperature and the difference is greater than the preset threshold range, then the controller 13 may be configured to control the power supply 11 to increase the output voltage of the power supply 11. For example, if the preset threshold range is set to 5 degrees Celsius and the liquid loaded in the steam boiler 121 of cleaning device 10 is ethanol, when the temperature measured by the temperature sensor 122 is greater than the preset working temperature by more than 5 degrees Celsius (e.g., 72 degrees Celsius), the controller 13 may be configured to control power supply 11 to increase the output voltage of the power supply 11. The controller 13 may be configured to control the opening and closing time of the power control switch 123 to increase the duty cycle of the voltage, thereby increasing the output voltage of the power supply 11. After a period of time, the controller 13 may be configured to obtain the temperature measured by the temperature sensor 122 again. If the temperature is lower than the preset working temperature but the difference is less than the preset threshold range, for example, 76 degrees Celsius, then the power supply may be provided according to the current output voltage.

Furthermore, the controller 13 can be configured to determine whether the temperature is greater than or equal to the preset over-temperature threshold. The preset over-temperature threshold can be set according to the type of liquid. For example, when the liquid is water, the preset over-temperature threshold can be set to 105 degrees Celsius, 110 degrees Celsius, 120 degrees Celsius, etc.

If the temperature is greater than or equal to the preset over-temperature threshold, then the controller 13 may be configured to control the power control switch 123 to disconnect, so that the power supply 11 stops supplying power to the steam boiler 121. For example, when the preset over-temperature threshold is set to 110 degrees Celsius, and the liquid loaded in the steam boiler 121 of cleaning device 10 is water, when the temperature measured by the temperature sensor 122 is greater than 110 degrees Celsius (e.g., 115 degrees Celsius), the controller 13 may be configured to control the power control switch 123 to disconnect, so that the power supply 11 stops supplying power to the steam boiler 121. After a period of time, the controller 13 may be configured to obtain the temperature measured by the temperature sensor 122 again. If the temperature is lower than 110 degrees Celsius, for example, 102 degrees Celsius, then the power supply may be provided according to the current output voltage. Setting the preset over-temperature threshold to disconnect the power control switch 123 improves the safety of the steam boiler 121 during operation, preventing steam burns and other accidents.

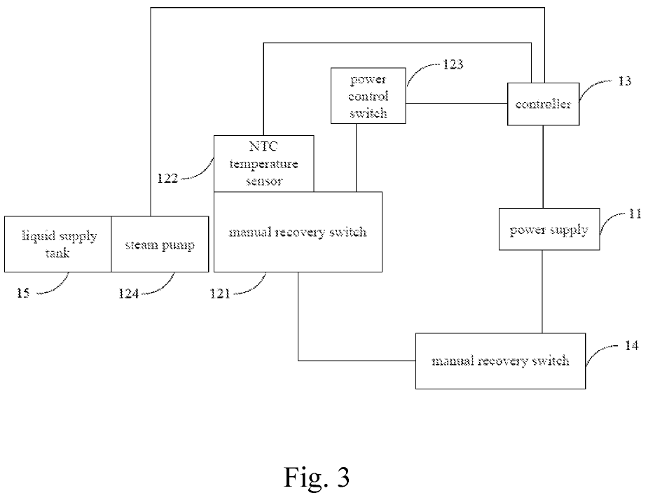

FIG. 3 shows a circuit structure diagram of the cleaning device 10. In an example, the cleaning device 10 may comprise a liquid supply tank 15. The steam generating component 12 may comprise a steam pump 124 controlled by the controller 13. The steam boiler 121 may be connected to the liquid supply tank 15 through the steam pump 124, which may pump the liquid in the liquid supply tank 15 to the steam boiler 121, where the liquid may be heated to generate steam. Furthermore, the steam pump 124 may be equipped with a circuit and a corresponding switch.

The steam boiler 121, the power control switch 123, the controller 13, the power supply 11, and the manual temperature recovery switch 14 may be connected in series. The steam pump 124 may be connected in parallel with the steam boiler 121 to the controller 13.

If the temperature is greater than or equal to the preset over-temperature threshold, then the controller 13 may be configured to control the power control switch 123 to disconnect and control the steam pump 124 to pump the liquid in the liquid supply tank 15 to the steam boiler 121 at maximum output power. For example, when the power control switch 123 is disconnected, the circuit of the steam pump 124 may be turned on, and the power supply 11 may output power at maximum output power to facilitate the steam pump 124 to pump the liquid in the liquid supply tank 15 to the steam boiler 121 at maximum output power.

For example, if the liquid loaded in the steam boiler 121 is water and the preset over-temperature threshold is set to 110 degrees Celsius, when the temperature of the steam boiler 121 is greater than or equal to 110 degrees Celsius (e.g., 120 degrees Celsius), the controller 13 may be configured to control the power control switch 123 to disconnect, and the steam boiler 121 may stop heating. At the same time, the controller 13 may be configured to control the steam pump 124 to pump the water in the liquid supply tank 15 to the steam boiler 121 at maximum output power, and the lower-temperature water in the liquid supply tank 15 may be mixed with the hot water in the steam boiler 121, reducing the overall water temperature. Setting the power control switch 123 to disconnect and controlling the steam pump 124 to pump the liquid to the steam boiler 121 when the temperature exceeds the preset over-temperature threshold improves the safety of the steam boiler 121 during operation, preventing steam burns and other accidents from occurring.

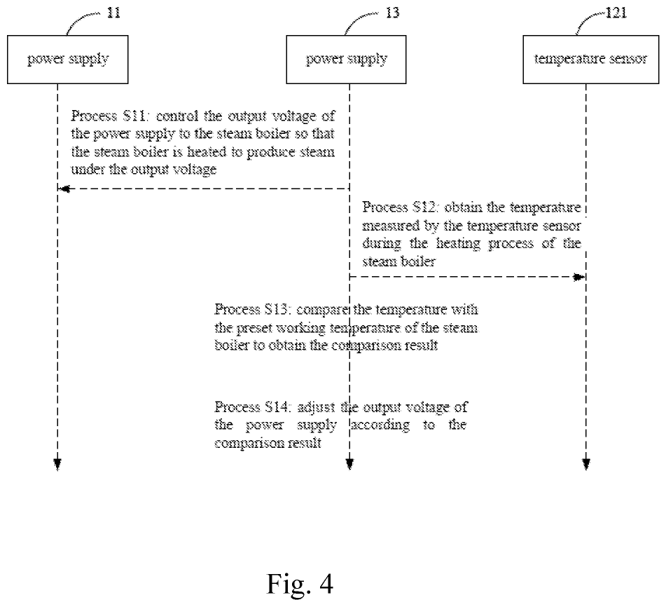

FIG. 4 shows a flowchart of a steam control method of a cleaning device. The method may include the following:
Step S1i: A computing device (a controller, the controller 13) may be configured to control the output voltage of a power supply to a steam boiler to heat and generate steam based on the output voltage. For example, the output voltage of the power supply 11 provided to the steam boiler 121 can be controlled by the controller 13.

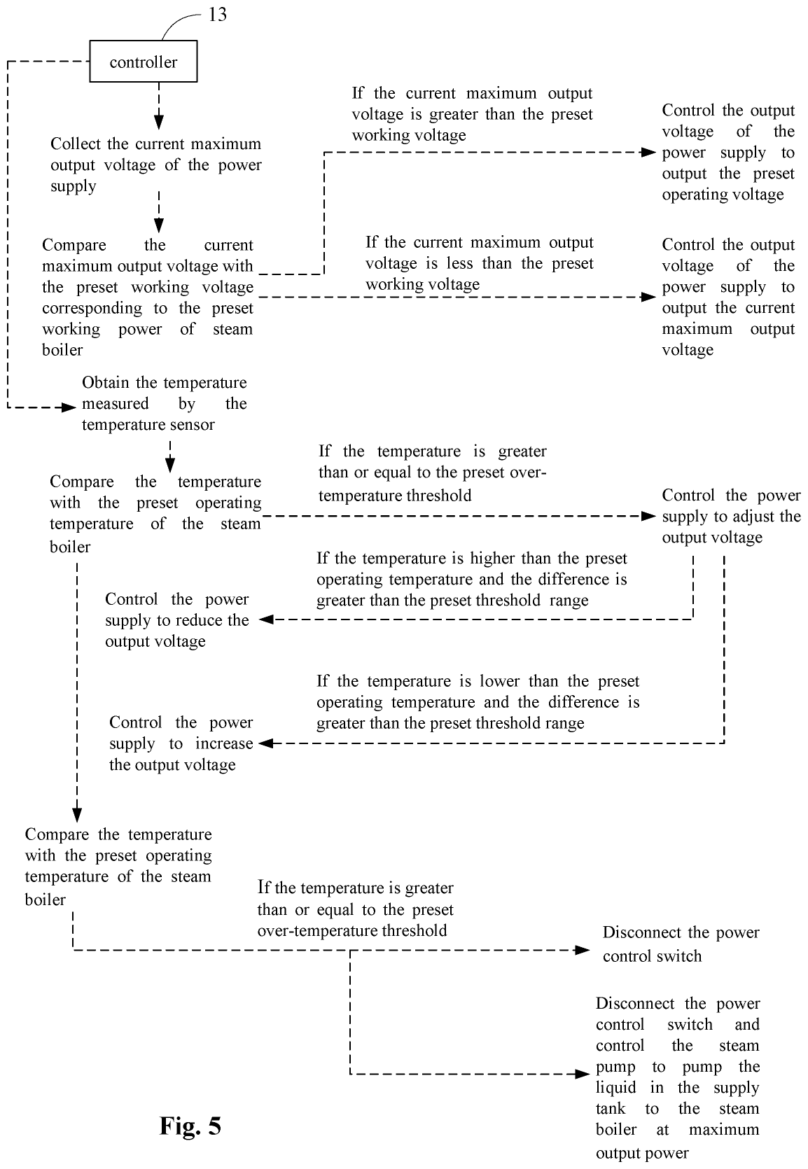

The specific steps of step S11 can be based on FIG. 5, which shows a flowchart of a steam control method of a cleaning device. Specifically, step S11 may include one or more of the following steps:
Step S111: The computing device may be configured to determine (e.g., collect) the current maximum output voltage of the power supply. For example, the current maximum output voltage of the power supply 11 can be determined by the controller 13.
Step S112: The computing device may be configured to compare the current maximum output voltage with a preset working voltage corresponding to a preset working power of the steam boiler. As the power supply 11 continues to supply power or is charged, its voltage (e.g., output voltage) may change. For example, when the power supply 11 continues to supply power, the voltage may decrease. When the power supply 11 is fully charged, it can supply power at the maximum rated voltage. Therefore, the power supply voltage and the preset working voltage of steam boiler 121 may be inconsistent in different scenarios. If the current maximum output voltage is equal to the preset working voltage of the steam boiler 121, then the power supply 11 may supply the steam boiler 121 with the current preset working voltage. If the current maximum output voltage is greater than the preset working voltage (e.g., the power supply 11 is fully charged), the following steps can be performed:
S113: The computing device may be configured to control the output voltage of the power supply to output the preset operating voltage. If the current maximum output voltage is equal to the preset operating voltage, then the power supply 11 may maintain the current preset operating voltage to supply (e.g., charge) the steam boiler 121. If the maximum output voltage is less than the preset operating voltage (e.g., the available power of power supply 11 is only 50% of full charge), the following steps can be performed:
Step S114: The computing device may be configured to control the output voltage of the power supply to output the current maximum output voltage. Steps S113 and S114 can be interchanged. The computing device may determine whether to perform step S113 or step S114 based on the comparison result of step S112.

The steps performed in step S11 can be called the “voltage feedback” step. The actual output voltage of the power supply 11 may be calculated by controlling the duty cycle of the output voltage of the power supply 11, so that the steam boiler 121 may operate at the preset operating voltage. After step S11 is completed, the “temperature” feedback step can be performed. For example, the actual temperature of the steam boiler 121 may be measured by the temperature sensor 122, and the actual temperature can be compared with the preset operating temperature, which can be used to adjust the output voltage of the power supply 11, turn on or off the power control switch 123, or control the steam pump 124 to pump the liquid in the supply tank 15 to the steam boiler 121. The following steps describe examples of the above features.
Step S12: The computing device may be configured to obtain the temperature measured by the temperature sensor during the heating process of the steam boiler. For example, the temperature sensor 122 can obtain the temperature of steam boiler 121 in real-time and send the temperature information to the controller 13. After receiving the temperature information sent by the temperature sensor 122, the controller 13 can perform the following steps:
Step S13: The controller may be configured to compare the temperature with the preset operating temperature of the steam boiler to obtain the comparison result. After receiving the temperature of the steam boiler 121, the controller 13 can compare the temperature with the preset operating temperature of steam boiler 121. After obtaining the comparison result, the controller 13 can perform the following steps:
Step S14: The controller may be configured to adjust the output voltage of the power supply according to the comparison result. For example, the controller 13 can adjust the output voltage of the power supply 11 based on the comparison result, such as lowering or increasing the output voltage of the power supply 11. Furthermore, the controller 13 can control the power control switch 123 to disconnect based on the comparison result. Furthermore, the controller 13 can control the steam pump 124 to pump the liquid in the supply tank 15 to the steam boiler 121 at maximum output power based on the comparison result.

FIG. 5 shows examples of the specific steps of step S14, which can comprise the following steps: After comparing the temperature of the steam boiler 121 with the preset operating temperature, the controller 13 may be configured to determine the comparison result. If the difference between the temperature of the steam boiler 121 and the preset operating temperature is greater than the preset threshold range, step S141 can be performed.
Step S141: The controller may be configured to control the power supply to adjust the output voltage so that the difference between the temperature and the preset working temperature is within the preset threshold range. For example, set the threshold range to 10 degrees Celsius. When the temperature measured by the temperature sensor 122 is greater than 10 degrees Celsius from the preset working temperature, the controller 13 may be configured to control the power supply 11 to adjust the output voltage so that the difference between the temperature and the preset working temperature is within 10 degrees Celsius.

The controller 13 may be configured to compare whether the temperature of the steam boiler 121 is greater than the preset working temperature and whether the difference is greater than the preset threshold range. If the comparison result is that the temperature is greater than the preset working temperature and the difference is greater than the preset threshold range, the following steps can be performed:
Step S142: The controller 13 may be configured to control the power supply to reduce the output voltage. Specifically, the controller 13 The controller 13 may be configured to control the opening and closing time of the power control switch 123 to reduce the duty cycle of the voltage and thereby reduce the output voltage of the power supply 11. After a period of time, the controller 13 may be configured to obtain the temperature measured by the temperature sensor 122 again. If the temperature is still greater than the preset working temperature but the difference is still greater than the preset threshold range, the following steps can be performed:
Step S143: The controller 13 may be configured to control the power supply to increase the output voltage. Specifically, the controller 13 The controller 13 may be configured to control the opening and closing time of the power control switch 123 to increase the duty cycle of the voltage and thereby increase the output voltage of the power supply 11. After a period of time, the controller 13 may be configured to obtain the temperature measured by the temperature sensor 122 again and further compares whether the temperature of the steam boiler 121 is greater than or equal to the preset over-temperature threshold.

Steps S142 and S143 can be performed interchangeably. The performance of step S142 or step S143 may be determined based on whether the temperature of the steam boiler 121 is greater than the preset working temperature and whether the difference is greater than the preset threshold range. If the temperature is greater than or equal to the preset over-temperature threshold, the following steps can be performed:
Step S144: The controller 13 may be configured to disconnect the power control switch to stop supplying power to the steam boiler. For example, when the preset over-temperature threshold is set to 112 degrees Celsius and the steam boiler 121 of the cleaning device 10 is loaded with water, the controller 13 may be configured to disconnect the power control switch 123 when the temperature measured by the temperature sensor 122 is 125 degrees Celsius, to stop supplying power to the steam boiler 121.

Additionally or alternatively, at Step S145: The controller 13 may be configured to disconnect the power control switch and control the steam pump to pump the liquid in the supply tank to the steam boiler at maximum output power. For example, the controller 13 may be configured to disconnect the power control switch 123 and simultaneously controls the steam pump 124 to pump the water in the supply tank 15 to the steam boiler 121 at maximum output power. Therefore, the steam boiler 121 may stop heating, and the lower temperature water in the supply tank 15 may be mixed with the hot water in the steam boiler 121, resulting in a decrease in overall water temperature.

Steps S144 and S145 can be performed interchangeably. The performance of step S144 or step S145 may be determined based on whether the temperature of the steam boiler 121 is greater than or equal to the preset over-temperature threshold. The different levels of over-temperature protection strategies further improve the safety of the cleaning device 10 during use.

The cleaning device 10 provided in this application can stabilize the generation of steam in the steam boiler 121 by controlling the output voltage of the power supply 11 through the controller 13 (e.g., “voltage feedforward” strategy). The cleaning device 10 can also measure the temperature of the steam boiler 121 through the temperature sensor 122, compare the temperature with the preset working temperature of steam boiler, and adjust the output voltage of the power supply 11 to heat the steam boiler 121 according to the comparison result (e.g., the “temperature feedback: strategy). The combination of the “voltage feedforward” strategy and the “temperature feedback” strategy enables the steam boiler 121 to generate steam stably and avoid the consequences of over-temperature.

The above description describes only examples of the present application and does not limit the scope of the present application. Any equivalent structure or equivalent process transformation made using the contents of the present application and drawings, or directly or indirectly applied in other related technical fields, is also included in the scope of the present application.

What is claimed is:

1. A cleaning device comprising:
a power supply for providing power;
a steam generating device comprising:
a steam boiler configured to heat a liquid to generate steam, and
a temperature sensor arranged on the steam boiler, wherein the steam boiler is electrically connected to the power supply, and wherein the temperature sensor is configured to measure a temperature of the steam boiler or the liquid; and
a controller electrically connected to the power supply and the temperature sensor, wherein the controller is configured to:
obtain the temperature measured by the temperature sensor during heating of the steam boiler,
compare the temperature with a preset working temperature of the steam boiler, and
adjust an output voltage of the power supply based on a comparison of the temperature with the preset working temperature.

2. The cleaning device according to claim 1, wherein the controller is further configured to:
obtain a maximum output voltage of the power supply,
compare the maximum output voltage with a preset working voltage of the steam boiler, and
control the output voltage of the power supply to output at the preset working voltage if the maximum output voltage is greater than the preset working voltage, or output at the maximum output voltage if the maximum output voltage is below the preset working voltage.

3. The cleaning device according to claim 1, wherein if a difference between the temperature and the preset working temperature is greater than a preset threshold range, the controller is configured to control the power supply to adjust the output voltage so that the difference between the temperature and the preset working temperature is within the preset threshold range.

4. The cleaning device according to claim 1, wherein if the temperature is greater than the preset working temperature and a difference is greater than a preset threshold range, the controller is configured to control the power supply to decrease the output voltage, and if the temperature is below the preset working temperature and the difference is greater than the preset threshold range, the controller is configured to control the power supply to increase the output voltage.

5. The cleaning device according to claim 1, wherein:
the steam generating device comprises a power control switch connected in series between the power supply and the steam boiler,
the power control switch is electrically connected to the controller, and
the controller is configured to control the output voltage of the power supply to the steam boiler through the power control switch.

6. The cleaning device according to claim 5, wherein the power control switch comprises a field-effect transistor, and the controller is configured to control the opening and closing of the power control switch to adjust a duty cycle of the output voltage of the power supply.

7. The cleaning device according to claim 5, wherein the controller is configured to determine whether the temperature is greater than or equal to a preset over-temperature threshold, and the controller is configured to control the power control switch to disconnect the power supply from the steam boiler based on a determination that temperature is greater than or equal to the preset over-temperature threshold.

8. The cleaning device according to claim 7, further comprising a liquid supply tank comprising the liquid, wherein:
the steam generating device comprises a steam pump electrically connected to the controller,
the steam boiler is connected to the liquid supply tank through the steam pump, and the steam pump is used to pump the liquid in the liquid supply tank to the steam boiler for heating and steam generation, and
based on a determination that the temperature is greater than or equal to the preset over-temperature threshold, the controller is configured to control the power control switch to disconnect the power supply from the steam boiler and control the steam pump to pump the liquid in the liquid supply tank to the steam boiler at maximum output power.

9. The cleaning device according to claim 1, wherein the temperature sensor comprises a negative temperature coefficient (NTC) sensor with an unencapsulated metal package.

10. The cleaning device according to claim 1, wherein the controller is configured to control an output voltage of the power supply to heat the steam boiler and generate steam at the output voltage.

11. A steam control method for a cleaning device comprising:
controlling, by a computing device, an output voltage of a power supply in a cleaning device to a steam boiler to heat the steam boiler and generate steam;
obtaining a temperature measured by a temperature sensor during heating of the steam boiler;
comparing the temperature with a preset working temperature of the steam boiler; and
adjusting the output voltage of the power supply based on a comparison of the temperature with the preset working temperature.

12. The steam control method of claim 11, further comprising:
obtaining a maximum output voltage of the power supply;
comparing the maximum output voltage with a preset working voltage of the steam boiler; and
controlling the output voltage of the power supply to output at the preset working voltage if the maximum output voltage is greater than the preset working voltage, or outputting at the maximum output voltage if the maximum output voltage is below the preset working voltage.

13. The steam control method of claim 11, further comprising:
based on a determination that the difference between the temperature and the preset working temperature is greater than a preset threshold range, controlling the power supply to adjust the output voltage so that the difference between the temperature and the preset working temperature is within the preset threshold range.

14. The steam control method of claim 11, further comprising:
based on a determination that the temperature is greater than the preset working temperature and the difference is greater than the preset threshold range,
controlling the power supply to decrease the output voltage.

15. The steam control method of claim 11, further comprising:
based on a determination that the temperature is below the preset working temperature and the difference is greater than the preset threshold range, controlling the power supply to increase the output voltage.

16. The steam control method of claim 11, wherein the controlling comprises controlling the output voltage of the power supply to the steam boiler through a power control switch, wherein the power control switch is connected in series between the power supply and the steam boiler.

17. The steam control method of claim 15, wherein the controlling comprises controlling the opening and closing of the power control switch to adjust a duty cycle of the output voltage of the power supply.

18. The steam control method of claim 15, further comprising:
determining whether the temperature is greater than or equal to a preset over-temperature threshold; and
based on a determination that temperature is greater than or equal to the preset over-temperature threshold, controlling the power control switch to disconnect the power supply from the steam boiler.

19. The steam control method of claim 11, further comprising:
based on a determination that the temperature is greater than or equal to a preset over-temperature threshold, controlling a steam pump to pump a liquid in a liquid supply tank to the steam boiler at maximum output power.

20. The steam control method of claim 11, wherein the temperature sensor comprises a negative temperature coefficient (NTC) sensor with an unencapsulated metal package.
